(19) United States
(12) Patent Application Publication
(10) Pub. No.: US 2012/0233352 A1
(43) Pub. Date: Sep. 13, 2012

(54) METHOD AND SYSTEM FOR MANAGING INTERNET ADDRESS BASED ON TERMINAL

(75) Inventor: Fei Li, Shenzhen (CN)

(73) Assignee: ZTE CORPORATION, Shenzhen, Guangdong (CN)

(21) Appl. No.: 13/509,970

(22) PCT Filed: Jun. 29, 2010
(86) PCT No.: PCT/CN2010/074723

§ 371 Date: May 15, 2012

(30) Foreign Application Priority Data
Dec. 15, 2009 (CN) 200910242706.8

(51) Int. Cl. G06F 15/16

(52) U.S. Cl. 709/245

(57) ABSTRACT

A method for terminal-based Internet address management is disclosed by the disclosure, and the method includes: a terminal sends a network address conflict message to a Universal Integrated Circuit Card (UICC) when a network address of a subnet which a terminal accesses conflicts with the network address of the subnet in which the UICC is currently located; after receiving the network address conflict message, the UICC releases an IP address currently used, and returns a corresponding release message to the terminal, wherein the IP address consists of a network address and a host address; the terminal and the UICC re-obtain non-conflicting IP addresses. Accordingly, a system for terminal-based Internet address management is also disclosed by the disclosure. Since the terminal of the disclosure can timely notify the UICC to change IP addresses when network address conflict occurs, the disclosure can prevent communication error caused by the conflict of network addresses, and thus improving communication stability.

### FIELD OF THE INVENTION

The disclosure relates to a technique for Internet Protocol (IP) address management, particularly relates to a method and system for terminal-based Internet address management.

### BACKGROUND OF THE INVENTION

For smart cards, mass Subscriber Identity Module (SIM) cards and multimedia SIM cards, it has been proposed that a Universal Integrated Circuit Card (UICC) is connected to a terminal through an InterChip Universal Serial Bus (IC-USB) interface, the Transmission Control Protocol (TCP)/Internet Protocol (IP) protocol stack is run on both the terminal and the UICC, and that communication between the two sides is achieved by inter-network equipment communication.

The UICC may support services such as Smart Card Web Server (SCWS)-based SIM cards and mass memory cards and may be accessed by the terminal through various applications. The specific structure is shown in FIG. 1.

It is stipulated by the European Telecommunications Standards Institute (ETSI) standard that internal IPs are used in the terminal and the UICC. Currently, IP address assignment mainly includes the following two approaches:
1) fixed IP addresses are used in the terminal and the UICC.

For example, the UICC uses a fixed IP address 192.168.0.1 and the terminal uses a fixed IP address 192.168.0.2.
2) the IP addresses are assigned by the Dynamic Host Configuration Protocol (DHCP) server in the terminal.

Since most of the existing terminals can access the Internet via various ports, the terminal, when connected to the UICC, can be connected to another network by another physical interface, e.g. the terminal can be connected to a Wireless Local Area Network (WLAN) by Wifi, or connected to a Personal Computer (PC) by a Universal Serial Bus (USB), through which the terminal communicates with a PC using a simulated Ethernet.

In the above cases, it is possible that the network address to which the terminal newly accesses conflicts with the network address of the current terminal or the UICC on the port connecting the current terminal and the UICC.

For example, if the IP address of the UICC is 192.168.0.1, while the IP address of the network which the terminal currently accesses is 192.168.0.0, when the subnet mask is 255.255.255.0, the IP address of the UICC conflicts with the IP address of the network currently accessed by the terminal, which results in communication error.

However, no solution has been proposed to solve this problem effectively.

### SUMMARY OF THE INVENTION

In view of the above, the main object of the disclosure is to provide a method and system for terminal-based internet address management, which can prevent communication error caused by network address conflict, and thus improve communication stability.

To achieve the above object, the technical solutions of the disclosure are implemented in the following ways.

A method for terminal-based internet address management includes the following steps:
when a network address of a subnet which terminal accesses conflicts with a network address of a subnet in which a Universal Integrated Circuit Card (UICC) is currently located, the terminal sends a network address conflict message to the UICC;
after receiving the network address conflict message, the UICC releases the currently used Internet Protocol (IP) address, and returns a corresponding release message to the terminal, wherein the IP address consists of a network address and a host address;
the terminal and the UICC re-obtain non-conflicting IP addresses.
the step that the terminal sends a network address conflict message to the UICC includes: a network address conflict management module of the terminal sends the network address conflict message to the UICC;
the step that the UICC releases an Internet Protocol (IP) address currently used includes:
after receiving the network address conflict message, a network address conflict management module of the UICC sends an IP address release request signal to a Dynamic Host Configuration Protocol (DHCP) client;
after releasing the IP address in response to the IP address release request signal, the DHCP client returns a response to the network address conflict management module of the UICC, and the DHCP client sends a DHCP release message to a DHCP server of the terminal.
the method further includes the following steps: obtaining, by the terminal and the UICC, their respective IP address during an initialization process; and intercepting at the specific port by the network address conflict management module of the UICC.
the network address conflict management module of the UICC intercepts using Port 67 for a DHCP service.
the step that the network address conflict management module of the terminal sends the network address conflict message to the UICC includes: the network address conflict management module of the terminal sends the network address conflict message to Port 67 of the UICC, using a User Datagram Protocol (UDP).

A system for terminal-based Internet address management, includes a terminal and a Universal Integrated Circuit Card (UICC), wherein
the terminal is configured, when a network address of a subnet which the terminal accesses conflicts with a network address of a subnet in which the UICC is currently located, to send a network address conflict message to the UICC; and when receiving a release message returned from the UICC, to re-obtain a non-conflicting IP address, wherein the IP address consists of a network address and a host address;
the UICC is configured, after receiving the network address conflict message from the terminal, to release an Internet Protocol (IP) address currently used, to return a corresponding release message to the terminal, and to re-obtain a non-conflicting IP address.
the terminal includes a network address conflict management module and a DHCP server; the UICC includes a network address conflict management module and a Dynamic Host Configuration Protocol (DHCP) client, wherein
the network address conflict management module of the terminal is configured, when the network address of the subnet which the terminal accesses conflicts with the network address of the subnet in which the UICC is currently located, to send a network address conflict message to the UICC;
the network address conflict management module of the UICC is configured, after receiving the network address conflict message from the network address conflict management module of the terminal, to send an IP address release request signal to the DHCP client;
the DHCP client is configured to release the IP address in response to the IP address release request signal from the network address conflict management module of the UICC, to return a response to the network address conflict management module of the UICC, and to send a DHCP release message to a DHCP server of the terminal.
the DHCP server is configured, after receiving the DHCP release message from the DHCP client, to re-assign IP addresses for the terminal and the UICC.
the terminal and the UICC are further configured to obtain their respective IP address during an initialization process; and
the network address conflict management module of the UICC is further configured to intercept at a specific port.
the network address conflict management module of the terminal is configured to intercept using Port 67 for a DHCP service.
the network address conflict management module of the terminal is configured to send the network address conflict message to Port 67 of the UICC, using a User Datagram Protocol (UDP).

According to the method and system for terminal-based Internet address management of the disclosure, when the network addresses of the terminal and the UICC conflict with the network address of another network, the terminal notifies the UICC of the network address conflict, the UICC releases the currently used IP address after receiving the notification, and sends a release message to the client. Subsequently, the DHCP client of the UICC returns to the initialization state and re-applies for an IP address. In the case of network address conflict, the terminal of the disclosure can timely notify the UICC to change the IP address. Therefore, communication error caused by the conflict of network addresses may be prevented, and thus communication stability may be improved.

### BRIEF DESCRIPTION OF THE DRAWINGS

FIG. 1 shows a structural diagram of a terminal and a UICC, which are connected through an IC-USB;

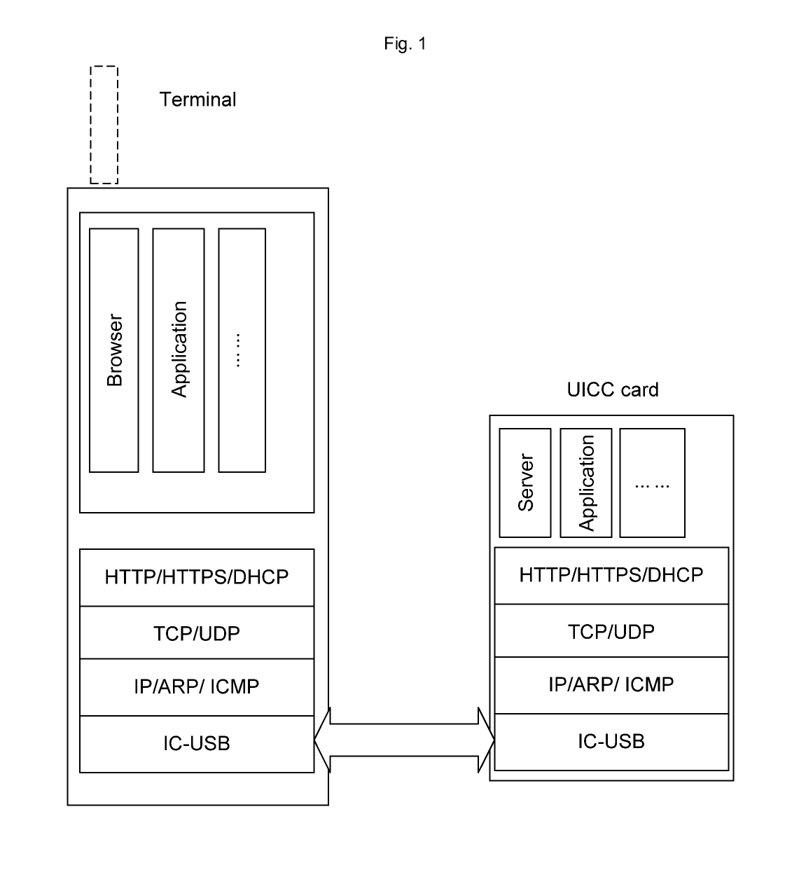

FIG. 2 shows a structural diagram of a terminal-based Internet address management system according to the disclosure;

FIG. 3 shows a structural diagram of the detailed structure of the terminal-based Internet address management system according to the disclosure;

FIG. 4 shows a flowchart of a method for terminal-based Internet address management according to the disclosure;

FIG. 5 shows a schematic diagram of a message format of a network address conflict message according to the disclosure; and

FIG. 6 shows a flowchart of a method for terminal-based Internet address management according to embodiment 1 of the disclosure.

### DETAILED DESCRIPTION OF THE INVENTION

The basic idea of the disclosure is that when the network addresses of a terminal and an UICC conflict with the network address of another network, the terminal notifies the UICC of the network address conflict. After receiving the notification, the UICC releases the current IP address being used, and sends a release message to the client. Subsequently, the DHCP client of the UICC returns to the initializing state and reapplies for an IP address.

The implementation of the technical solution is described below with reference to the accompanying drawings in details.

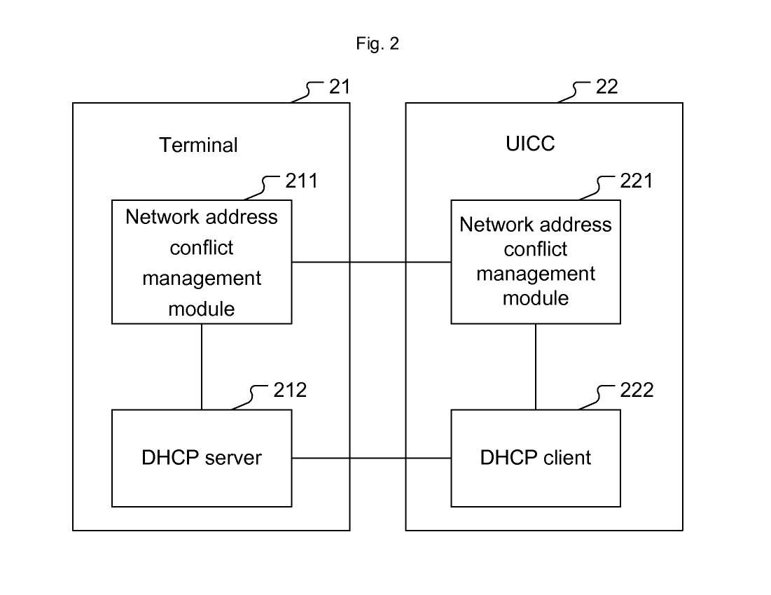

FIG. 2 shows a structural diagram of a terminal-based Internet address management system according to the disclosure.

As shown in FIG. 2, the terminal-based Internet address management system according to the disclosure includes
a terminal 21 and a UICC 22, wherein
the terminal 21 includes a network address conflict management module 211 and a DHCP server 212, and the UICC 22 includes a network address conflict management module 221 and a DHCP client 222, wherein
the network address conflict management module 211 of the terminal is configured to send a network address conflict message to the UICC 22 when the network address of the network which terminal 21 accesses conflicts with the network address of the subnet in which the UICC is currently located;
the network address conflict management module 221 of the UICC is configured to send an IP release request signal to the DHCP client 222 after receiving the network address conflict message from the network address conflict management module 211 of the terminal;
the DHCP client 222 is configured to release the IP address according to the IP release request signal from the network address conflict management module 221 of the UICC, to return a response to the network address conflict management module 221 of the UICC and to send a DHCP release message to the DHCP server 212 of the terminal;
the DHCP server 212 is configured to reassign IP addresses for the terminal 21 and the UICC 22, after receiving the DHCP release message from the DHCP client 222.

The terminal 21 and the UICC 22 are further configured to obtain their respective IP address during initialization processes.

The network address conflict management module 221 of the UICC is further configured to perform interception at a specific port.

The network address conflict management module 221 of the UICC is further configured to perform interception using Port 67 for the DHCP service.

The network address conflict management module 211 of the terminal is further configured to send the network address conflict message to Port 67 of the UICC through the UDP.

FIG. 2 only involves the related main components of the terminal and the UICC of the disclosure, and relevant interfaces and protocol stacks are not shown.

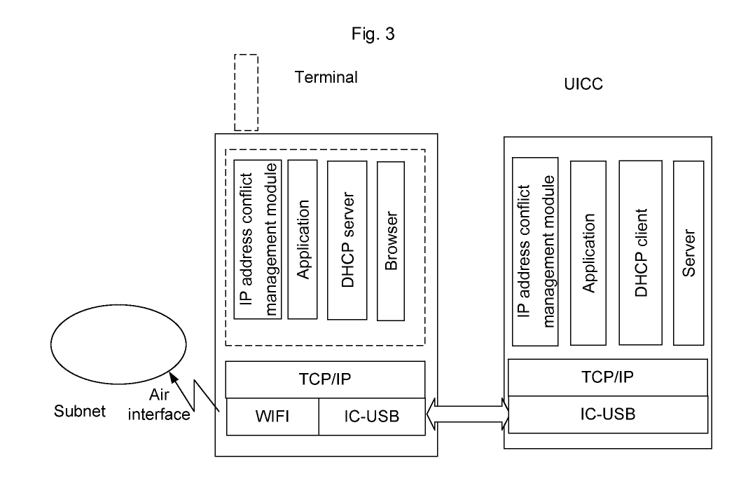

FIG. 3 shows a structural diagram of the detailed structure of a terminal-based Internet address management system.

As shown in FIG. 3, a mobile terminal includes a browser, an application, a DHCP server, a network address conflict management module, a TCP/IP protocol stack, an IC-USB interface and a WIFI module.

A UICC card includes a server, an application, a DHCP client, a network address conflict management module, a TCP/IP protocol stack and an IC-USB interface.

The terminal and the UICC are connected through an IC-USB port, and the terminal can access another network through the WIFI module.

The network address conflict management module at the terminal side and the network address conflict management module at the UICC side can be integrated with the DHCP server and the DHCP client, respectively or can be operated independently.

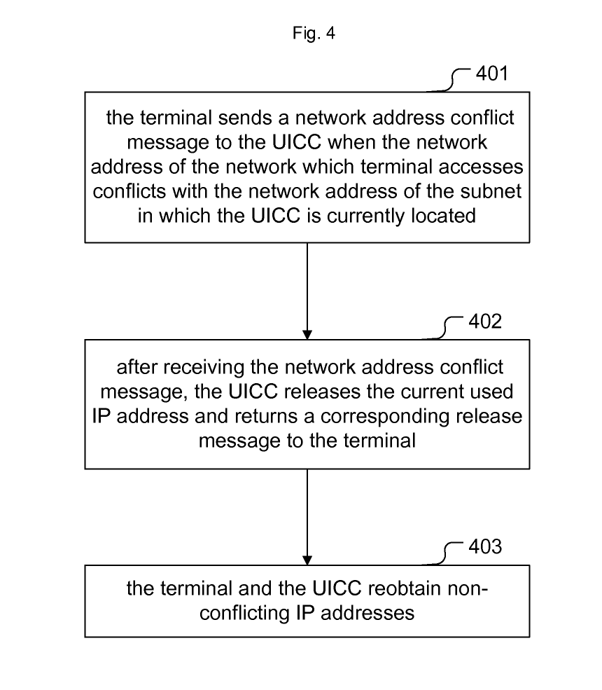

FIG. 4 shows a flowchart of a terminal-based Internet address management method according to the disclosure.

As shown in FIG. 4, the terminal-based Internet address management method according to the disclosure includes the following steps.

Step 401: the terminal sends a network address conflict message to the UICC when the network address of the network which terminal accesses conflicts with the network address of the subnet in which the UICC is currently located.
an IP address consists of a network address and a host address.

In the disclosure, when the subnet segment address of the IP address of the network which the terminal currently accesses conflicts with the subnet segment address of the IP address of the connection port between the terminal and the UICC, it is considered as a network address conflict.

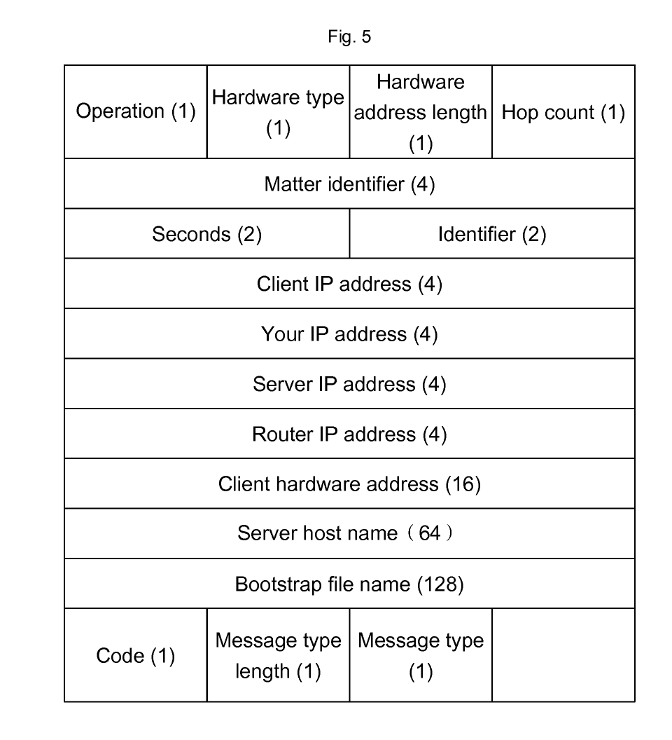

FIG. 5 shows a schematic diagram of a message format of a network address conflict message according to the disclosure.

For the message format as shown in FIG. 5, the terminal can set the operation field as 2, which indicates that the network address conflict message is sent by the terminal to the UICC;

the hardware type is set as 1, representing the Ethernet; the IP address of the UICC is written in both the client address and local IP address; the terminal IP address is written in both the server IP address and the router IP address;
the Ethernet address is written in the client hardware address; Localtermal is written in the server host name;
the bootstrap file is null and the code is set as 53, representing the message type. The message type length is 1, representing the subsequent length of 1 byte; the message type is set as 8, indicating that the message is an IP address conflict message. The contents of other fields can be added according to the DHCP definitions.

Step 402: after receiving the network address conflict message, the UICC releases the current IP address being used and returns a corresponding release message to the terminal.

It is to be noted that, the release of the IP address and the return of the corresponding release message may be performed concurrently or according to a certain sequence.

Step 403: the terminal and the UICC obtain non-conflicting IP addresses.

The implementation of the technical solution is described below with reference to the specific embodiments in details.

### Embodiment 1

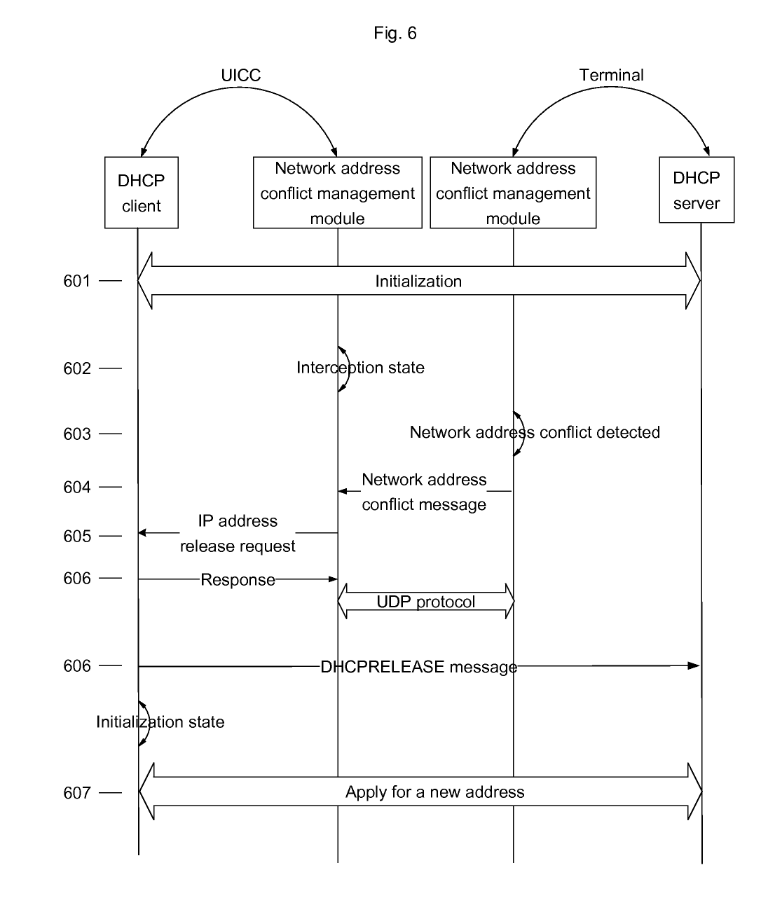

FIG. 6 shows a flowchart of a terminal-based Internet address management method according to embodiment 1 of the disclosure.

As shown in FIG. 6, the terminal-based Internet address management method according to embodiment 1 of the disclosure includes the following steps:

Step 601: the terminal and the UICC obtain their respective IP address during an initialization process.

For example, during the initialization process, the UICC and the terminal obtain IP addresses 192.168.0.1 and 192.168.0.2 respectively and a subnet mask 255.255.255.0 at the IC-USB port.

Step 602: the network address conflict management module of the UICC performs an interception at the specific port.

For example, the network address conflict management module of the UICC can use Port 67 for the DHCP service to perform the interception.

Step 603: when the terminal accesses another subnet, it is determined whether the network address of the subnet conflicts with the network address for the IP address obtained in Step 601.

When the terminal accesses another subnet through the WIFI module, if the IP address obtained through he DHCP is an IP address of the same subnet, e.g. the IP address is also 192.168.0.2 and the subnet mask is 255.255.255.0, this will result in a network address conflict.

Step 604: the network address conflict management module of the terminal sends the network address conflict message to the UICC.

For example, the network address conflict management module at the terminal side can send a network address conflict message to Port 67 of the UICC through the UDP.

Step 605: after receiving the network address conflict message, the network address conflict management module of the UICC sends an IP release request signal to the DHCP client.

Step 606: the DHCP client returns a response to the network address conflict management module of the UICC and sends a DHCP release message (DHCPRELEASE) to the DHCP server of the terminal, and the UICC returns to a DHCP initialization state.

Step 607: the terminal and the UICC re-obtain non-conflicting IP addresses.

Here, the IP addresses re-obtained by the terminal and the UICC are generally assigned by the DHCP server.

Specifically, after receiving the DHCP release message, the DHCP server confirms that the UICC has released the original IP address. The network address conflict management module of the terminal configures the IP address of the connection port between the terminal and the UICC as an IP address of another subnet, e.g. 192.168.1.2, with the subnet mask 255.255.255.252,
and configures IP addresses assigned by the DHCP server within a range of the same subnet.

Accordingly, the UICC card can re-use the DHCP to apply for a new IP address from the DHCP server of the terminal, e.g. 192.168.1.1 with the subnet mask 255.255.255.252.

In this way, the problem of network address conflict is solved.

The above contents serve only as preferred embodiments of the present disclosure and are not intended to limit the scope of the present disclosure.

1. A method for terminal-based Internet address management, comprising:
sending, by the terminal, a network address conflict message to the UICC when a network address of a subnet which a terminal accesses conflicts with a network address of a subnet in which a Universal Integrated Circuit Card (UICC) is currently located;
releasing, by the UICC, in response to the network address conflict message, an Internet Protocol (IP) address currently used, wherein the IP address consists of a network address and a host address;
returning, by the UICC, a corresponding release message to the terminal; and
obtaining, by the terminal and the UICC, non-conflicting IP addresses.

2. The method according to claim 1, wherein the sending, by the terminal, the network address conflict message to the UICC further comprises:
sending, by a network address conflict management module of the terminal, the network address conflict message to the UICC;
the releasing, by the UICC, the Internet Protocol (IP) address currently used comprises:
sending, by a network address conflict management module of the UICC, an IP address release request signal to a Dynamic Host Configuration Protocol (DHCP) client;
releasing, by the DHCP client, the IP address in response to the IP address release request signal;
returning, by the DHCP client, a response to the network address conflict management module of the UICC; and sending, by the DHCP client, a DHCP release message to a DHCP server of the terminal.

3. The method according to claim 2, further comprising: obtaining, by the terminal and the UICC, their respective IP address during an initialization process; and
intercepting at a specific port by the network address conflict management module of the UICC.

4. The method according to claim 3, wherein the network address conflict management module of the UICC intercepts using Port 67 for a DHCP service.

5. The method according to claim 2, wherein the sending, by the network address conflict management module of the terminal, the network address conflict message to the UICC further comprises: sending, by the network address conflict management module of the terminal, the network address conflict message to Port 67 of the UICC, using a User Datagram Protocol (UDP).

6. A system for terminal-based Internet address management, comprising: a terminal and a Universal Integrated Circuit Card (UICC), wherein
the terminal is configured, when a network address of a subnet which the terminal accesses conflicts with a network address of a subnet in which the UICC is currently located, to send a network address conflict message to the UICC; and wherein the terminal is further configured to receive a release message from the UICC, and to obtain a non-conflicting IP address, wherein the IP address consists of a network address and a host address;
the UICC is configured, to receive the network address conflict message from the terminal, to release an Internet Protocol (IP) address currently used, to return a corresponding release message to the terminal, and to obtain a non-conflicting IP address.

7. The system according to claim 6, wherein the terminal comprises a network address conflict management module and a DHCP server; and the UICC comprises a network address conflict management module and a DHCP client, wherein
the network address conflict management module of the terminal is configured, when a network address of a subnet which the terminal accesses conflicts with a network address of a subnet in which the UICC is currently located, to send a network address conflict message to the UICC;
the network address conflict management module of the UICC is configured, to send an IP address release request signal to a DHCP client;
the DHCP client is configured to release the IP address in response to the IP address release request signal from the network address conflict management module of the UICC, to return a response to the network address conflict management module of the UICC, and to send a DHCP release message to a DHCP server of the terminal; and
the DHCP server is configured, to re-assign IP addresses for the terminal and the UICC.

8. The system according to claim 7, wherein the terminal and the UICC are further configured to obtain their respective IP address during an initialization process; and
the network address conflict management module of the UICC is further configured to intercept at a specific port.

9. The system according to claim 8, wherein the network address conflict management module of the UICC is further configured to intercept using Port 67 for a DHCP service.

10. The system according to claim 7, wherein the network address conflict management module of the terminal is further configured to send the network address conflict message to Port 67 of the UICC, using a User Datagram Protocol (UDP).

11. The method according to claim 3, wherein the sending, by the network address conflict management module of the terminal, the network address conflict message to the UICC further comprises: sending, by the network address conflict management module of the terminal, the network address conflict message to Port 67 of the UICC, using a User Datagram Protocol (UDP).

12. The method according to claim 4, wherein the sending, by the network address conflict management module of the terminal, the network address conflict message to the UICC further comprises: sending, by the network address conflict management module of the terminal, the network address conflict message to Port 67 of the UICC, using a User Datagram Protocol (UDP).

13. The system according to claim 8, wherein the network address conflict management module of the terminal is further configured to send the network address conflict message to Port 67 of the UICC, using a User Datagram Protocol (UDP).

14. The system according to claim 9, wherein the network address conflict management module of the terminal is further configured to send the network address conflict message to Port 67 of the UICC, using a User Datagram Protocol (UDP).
